(19) United States
(12) Patent Application Publication
(10) Pub. No.: US 2007/0162497 A1
(43) Pub. Date: Jul. 12, 2007

(54) Searching in a melody database

(75) Inventor: Steffen Clarence Pauws, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/596,135

(22) PCT Filed: Nov. 22, 2004
(86) PCT No.: PCT/IB04/52499

§ 371 Date: Jun. 1, 2006

(30) Foreign Application Priority Data
Dec. 8, 2003 (EP) 03104572.7

(51) Int. Cl. G06F 7/00

(52) U.S. Cl. 707/104.1

(57) ABSTRACT

A system for searching for a query string, that represents an audio fragment, in a melody database (114) includes an input (122, 132) for receiving the query string from a user. The melody database (114) stores respective representations of plurality of audio fragments. A processor (116) is used to decompose (117) the query string into a sequence of a plurality of query sub-strings. Each sub-string is independently searched (118) in the database for at least a respective closest match for the sub-string. In dependence on the search results for the respective sub-strings, a closest match for the query string is determined (119).

### FIELD OF THE INVENTION

The invention relates to a method of searching for a query string, that represents an audio fragment, in a melody database. The invention further relates to a system for searching for a query string, that represents an audio fragment, in a melody database and to a server for use in such a system.

### BACKGROUND OF THE INVENTION

With the increase of audio distribution through the Internet, retrieval of a specific audio track/title has also become more important. Traditionally, a user could search audio titles/tracks on metadata, such as artist name, composer, record company, etc. A search was then performed through a database for matching audio tracks. The user could then select one of the, possibly several, hits for playback/downloading. Since the user may not always be able to specify any suitable metadata, other forms of a specifying query string have also become available. U.S. Pat. No. 5,963,957 describes the so-called ‘query by humming’ approach. A user can simply hum a part of an audio track. The audio fragment that has been hummed by the user is converted to a query string (e.g. by converting the hummed fragment into a sequence of tones or tone differences). The database is then searched for matching tracks (or, more in general, longer audio fragments that include the hummed fragment). The matching is based on a distance measure. Statistical criteria may be used. Other audio input modalities are also known, like singing, whistling or tapping.

### SUMMARY OF THE INVENTION

It is an object of the invention to provide an improved method, system, and server of the kind set forth that provides an increased accuracy in locating the audio fragment in the database.

To meet the object of the invention, a method of searching for a match for a query string, that represents an audio fragment, in a melody database, includes:

decomposing the query string into a sequence of a plurality of query sub-strings;

for each sub-string, independently searching the database for at least a respective closest match for the sub-string; and

in dependence on the search results for the respective sub-strings, determining at least a closest match for the query string.

The inventor has realized that the query string representing the audio input by a user may in fact actually not be one coherent sequential part of a larger audio fragment represented in the database. For example, a user may have provided a query string representing an audio fragment with two phrases: the user started by singing a phrase of the main lyrics, followed by a phrase of the chorus, skipping the phrases that lie in between the first phrase and the chorus phrase. Had the user only provided one of the phrases a ‘perfect’ match might have been found in the database. The conventional searching method tries to match the entire sequence of both phrases against the database. In many cases this will not give a very close match (if any can be detected reliably at all) and will at least reduce the accuracy of the system. According to the invention, the query string is decomposed into a sequence of a plurality of query sub-strings. The sub-strings are independently matched against the audio representations stored in the database. The outcome of the individual matching operations are used to determine a match for the entire query string. In the example where the user has provided two non-sequential phrases as the query string, both phrases can be located much more reliably. If both show a good match for a same audio track, that track can very reliably be identified as the match for the entire query.

Recently, high capacity local systems capable of storing audio have become popular. Such systems can take any form, such as a PC with an audio juke-box, a set-top box with built-in tuner and hard disk, a hard disc recorder, etc. Also portable high capacity audio storage systems are becoming available, such as the Apple iPod and Philips HDD100. These local storage system can easily store thousands of audio tracks. Conventionally, such systems enable a user to retrieve a specific track by specifying one or more metadata items, like artist, title, album, etc. The method according to the invention can also be used for quickly selecting an audio track in such system, in particular in these cases where the user has forgotten relevant metadata.

According to the measure of the dependent claim 2, the decomposition splits the query up into sub-strings that each correspond to a phrase. A phrase boundary may be detected in any suitable way, for example a phrase is usually 8 to 20 notes long, hinging on a central tone. Between phrases a pause occurs to enable breathing and the central tone may change. Phrases are often ended by a slowing down of the humming. Or, phrases are discriminative by large tone differences (i.e. intervals) and large tone durations. By separately recognizing sequential phrases represented in the query string, accuracy increases.

According to the measure of the dependent claim 3, a user may provide a query string that represents an audio fragment that is a mixture of a plurality of audio parts that have been input using different input modalities. Conventional melody databases only support one type of input modality. So, the user has to use the input type of the database. According to the invention, the database can be searched for audio fragments input using multiple modalities. According to the measure of the dependent claim 4, at least one of the query input modalities is one of: humming, singing, whistling, tapping, clapping, percussive vocal sounds. In principle, any suitable input modality may be used, as long as the database supports the type.

According to the measure of the dependent claim 5, whenever a change in input modality is detected a new sub-string is started. As described above, conventional melody databases can only be searched for the entire query string. The inventor has realized that users may change input modality during inputting of the audio fragment represented by the query string. For example, a user may sing a phrase of the chorus and may hum a phrase of the main lyrics. By splitting the query string, the parts corresponding to the different input modalities can be searched for separately, for example using databases optimized for the respective input modalities or by representing a same phrase in the database separately for each modality.

According to the measure of the dependent claim 6, an iterative automatic process is used that optimizes the location and size of the sub-strings. In this way, automatically a decomposition can be found. An initial estimate is made of the number of sub-strings. Each sub-string will be represented by a respective centroid (with audio characteristics of the sub-string). Thus, the initial estimate determines the initial number of centroids. The initial locations of the centroids may be chosen equidistantly distributed along the audio fragment. The sub-strings may initially be equal size. The procedure then minimizes the distance between the sub-string and its centroid. A jump from one input modality to another will usually negatively influence the distance. So, if a sub-string initially overlapped two successive input modalities in the audio fragment, the minimization tends to shift a boundary of the sub-string until it mainly falls within the same input modality as its centroid. Similarly, the boundary of the next sub-string will be shifted.

According to the measure of the dependent claim 7, an initial estimate of the number of sub-strings (and thus of the number of centroids) is based on the duration of the audio fragment compared to the average duration of a phrase. For example, an audio fragment with 40 tones may be assumed to include a maximum of 5 phrases (based on a minimum phrase length of 8 tones). So, the iteration could start with 5 centroids, equidistantly distributed along the audio fragment. Preferably, this number of centroids is used as the maximum number of centroids. A same optimization may also be performed for fewer centroids to cover the situation where the fragment is highly coherent (e.g., the user sang a correct sequence of phrases).

According to the measure of the dependent claim 8, instead of or in addition to using the automatic minimization procedure that implicitly segments the query string into more consistent sub-strings (where the distance measure acts as an implicit classification criterion), also explicit classification criteria may be used for segmentation. Each part of the query string that is assigned to the same sub-string meets the same predetermined classification criterion, and each two sequential substrings meet different predetermined classification criteria. The different classification criteria represent audio characteristics of the respective input modalities. For example, some input modalities, like singing and humming, have a clear pitch, whereas others, like percussion-imitations, do not have a clear pitch (i.e., are noisy). It will be appreciated that some of the characteristics may be absolute in the sense that they apply to all users, whereas certain characteristics may be relative (e.g., the pitch level of whistling relative to the singing/humming pitch) and can only be set after analyzing the entire audio fragment or after an initial training by the user.

According to the measure of the dependent claim 9, the classification result in detecting boundaries in the input query string indicating a change in input modality. The detected boundary (or boundaries) are then used as a constraint for the automatic segmentation that a sub-string has to fall between two such successive boundaries (i.e. a sub-string may not overlap a boundary). It will be appreciated that more than one sub-string (e.g., two sung phrases) may be located between two boundaries. In this, the start and end of the audio fragment also count as boundaries.

According to the measure of the dependent claim 10, searching the database for a match for each of the sub-strings gives for each sub-string an N-best list (N>=2) of the N most closest corresponding parts in the database with a corresponding measure of resemblance. Based on the obtained N-best lists the optimal match for the entire query string is determined (or an N-best list is created for the entire query string).

To meet an object of the invention, a system for searching for a match for a query string, that represents an audio fragment, in a melody database, includes:

an input for receiving the query string from a user;

a melody database for storing respective representations of plurality of audio fragments;

at least one processor for, under control of a program,
decomposing the query string into a sequence of a plurality of query sub-strings;
for each sub-string, independently searching the database for at least a respective closest match for the sub-string; and
in dependence on the search results for the respective sub-strings, determining at least a closest match for the query string.

These and other aspects of the invention are apparent from and will be elucidated, by way of a non-limitative example, with reference to the embodiments described hereinafter.

### BRIEF DESCRIPTION OF THE DRAWINGS

In the drawings:

FIG. 1 shows a block diagram of a distributed system performing the method according to the invention;

FIG. 2 shows a stand-alone device performing the method according to the invention;

FIG. 3 shows a flow-chart of an embodiment of the method; and

FIG. 4A and 4B show exemplary sub-divisions.

### DETAILED DESCRIPTION OF THE PREFERRED EMBODIMENT

According to the invention, a query string is divided into sub-strings, that are individually searched for in a database, and a match is determined based on the outcomes. The sub-division preferably reflects changes in input modality. Such a sub-division may be achieved in several ways. Below, a minimization algorithm using dynamic programming is described and a classification approach is described. Also combined approaches may be used, for example where classification is used as a pre-analysis for the minimization. As an alternative to performing the sub-division on a change in input modality, the sub-division may be based on a change of phrase. Any suitable phrase detection algorithm may be used. Preferably, sub-division on changes in input modality and phrases are combined. For example, first a sub-division is done aimed at creating sub-strings whenever a change in input modality occurs. These sub-strings are further sub-divided whenever a change in phrase is detected.

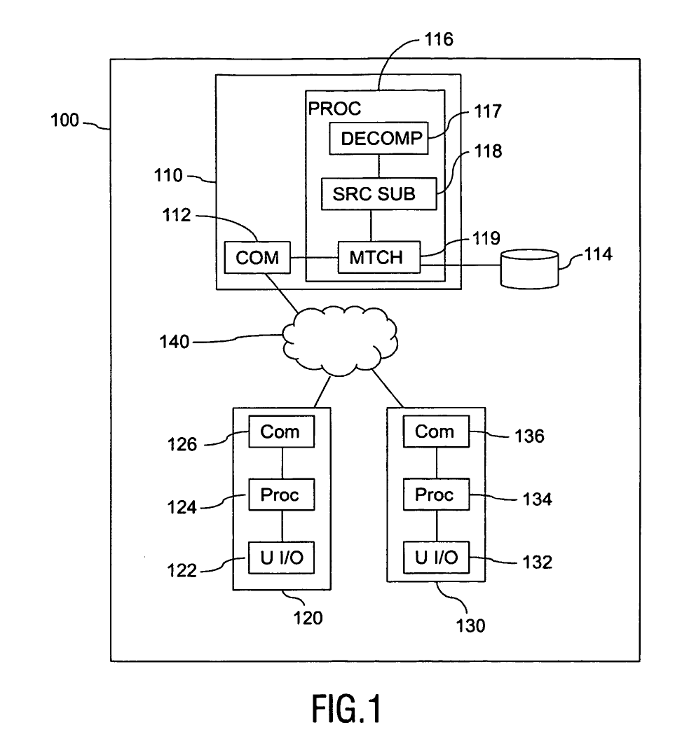

FIG. 1 shows a block diagram of an exemplary system 100 in which the method according to the invention can be employed. In this system 100, the functionality is distributed over a server 110 and a client (shown are two clients 120 and 130). The server 110 and clients 120/130 can communicate via a network 140. This may be a local area network, such as Ethernet, WiFi, Bluetooth, IEEE 1394, etc. Preferably, the network 140 is a wide area network, like Internet. The devices include suitable hardware/software (shown in the server 110 as item 112 and in the clients as respective items 126 and 136) for the communication through the network 140. Such communication HW/SW is known and will not be described any further.

In the system according to the invention, the user directly or indirectly specifies a query string that represents an audio fragment. Using the subdivision of functionality of FIG. 1, the user specifies the query string using one of the clients 120 or 130 via the respective user interface 122, 132. The client may be implemented on a conventional computer, like a PC, or computer-like device, such as a PDA. In particular, the client may be implemented on a device that includes a music library (similar to those known from Real One, Windows Media Player, Apple iTunes, etc.) to enable a user to specify an audio track to be played from the library or to be downloaded into the library. Any suitable user interface may be used, like a mouse, keyboard, microphone, etc. In particular, the user may specify an audio fragment using audio or audio-like input, such as vocal input. For example, the user may sing, hum, whistle, tap, etc. an audio fragment. The audio fragment may be received by the client through a microphone. The microphone may be a traditional analogue microphone, in which case the client may include an A/D converter, such as is normally present on an audio card of a PC. The microphone may also be a digital microphone that already includes an A/D converter. Such a digital microphone may be connected to the client 120/130 in any suitable form, e.g. using USB, Bluetooth, etc. The audio fragment may also be entered in other forms, such as specifying the notes using conventional input devices, e.g. using a mouse or the standard PC text keyboard, or using a music keyboard attached to a PC.

Preferably, the client performs some form of preprocessing for converting the audio fragment into the query string. Such preprocessing may be performed by the processor 124/134 under control of a suitable program. The program is loaded from a non-volatile memory, such as a hard disk, ROM, or flash memory, into the processor 124/134. The preprocessing may be limited to compressing the audio fragment, for example using MP3 compression. If the audio fragment is already present in a suitably compressed form, like the Midi format, no further preprocessing may be required in the client 120/130. The preprocessing may also include a conversion into a format suitable for searching through the melody database 114. In principle any suitable method may be used for representing the actual audio content of an audio fragment in the database. Various ways of doing so are known for this, like describing the fragment as a sequence of tones, optionally with a note duration. Also forms are known where not the absolute tone sequence is given, but only changes of tone values are given (tone increase, same tone, tone decrease). If so desired, the melody database may also include spectral information of the audio fragments. Techniques are generally known from the field of audio processing, and in particular, from the field of speech processing for representing audio and/or vocal input in a form suitable for further analysis and in particular for searching through a database for a match. For example, pitch detection techniques are generally known and can be used for establishing the tone values and tone durations. Such techniques are not part of the invention.

For the system according to the invention any suitable form of specifying the query string for access to the database 114 may be used, as long as the database 114 supports the query string formats. The database is operative to search the records of the database for a match of a query. Melody databases that support such queries are known. Preferably, the match does not need to be a ‘full’ match but is a ‘statistical’ match, i.e. one or more records in the database are identified with a field that resembles the query. The resemblance may be a statistical likelihood, for example based on a distance measure between the query item and the corresponding field of the database. Preferably, the database is indexed to enable quicker retrieval of a match. The non pre-published patent application with attorney docket no. PHNL030182 describes a method of indexing a database that supports non-exact matches. It will be understood that the database for an identified record stores information that may be useful to the user of the system. Such information may include bibliographic information on the fragment identified, like composer, performing artist, recording company, year of recording, studio, etc. A search through the database may identify one or more ‘matching’ records (preferably in the form of an N-best list with for example, the ten most likely hits in the database) and present these records together with some or all of the stored bibliographical data. In the arrangement of FIG. 1, the information is supplied through the network from the server to the client that specified the query. The user interface of the client is used for presenting the information to the user (e.g. using a display or voice-synthesis) or for performing a further automatic operation, like downloading the identified audio track or album in full from an Internet server. It is preferred that the database can be searched for a phrase or even smaller fragments, such as half a phrase, to increase the robustness of the searching.

According to the invention, the query string is decomposed into a sequence of a plurality of query sub-strings. For each sub-string, the database is independently searched for at least a respective closest match for the sub-string. As described above, this preferably results in an N-best list (N≧2) of the N most closest corresponding parts in the database with a corresponding measure of resemblance. The measure of resemblance may be a distance or a likelihood. Suitable distance measures/likelihoods are known to the persons skilled in the art and will not be described further. In dependence on the search results for the respective sub-strings, the system determines at least a closest match for the entire query string. Preferably, the system produces an N-best list (N≧2) for the entire string so that the user can make the final selection from a limited list of likely candidates. For systems wherein the database can supply N-best lists for the sub-strings the match for the entire query string is then preferably based on the measures of resemblance of the N-best lists of the sub-strings. It is well-known how from results for sub-matches an outcome for the entire match can be created, for example, by merging the N-best lists for the sub-strings into one N-best list. This may be done by ordering all items in the lists on their normalized distances to the sub-string. Alternatively, the mean normalized distances of equivalent items in the N-best lists can be computed. Normalization is required since sub-strings have different lengths. Recall that an item occurs in each N-best list, for the latter represents an ordering of all melodies. This mean can be used to order the items. In both cases, the top item then represents the best candidate for the given decomposition.

FIG. 1 illustrates that a processor 116 of the server 110 is used to perform the method according to the invention of decomposing 117 the query string, searching 118 the database for matches for each sub-string, and determining 119 an outcome based on the matches for the sub-string. The server may be implemented on any suitable server platform, such as those known from Internet servers. The processor may be any suitable processor, for example Intel's server processors. The program may be loaded from a background storage, such as a hard disk (not shown). The database may be implemented using any suitable database management system, such as Oracle, SQL-server, etc.

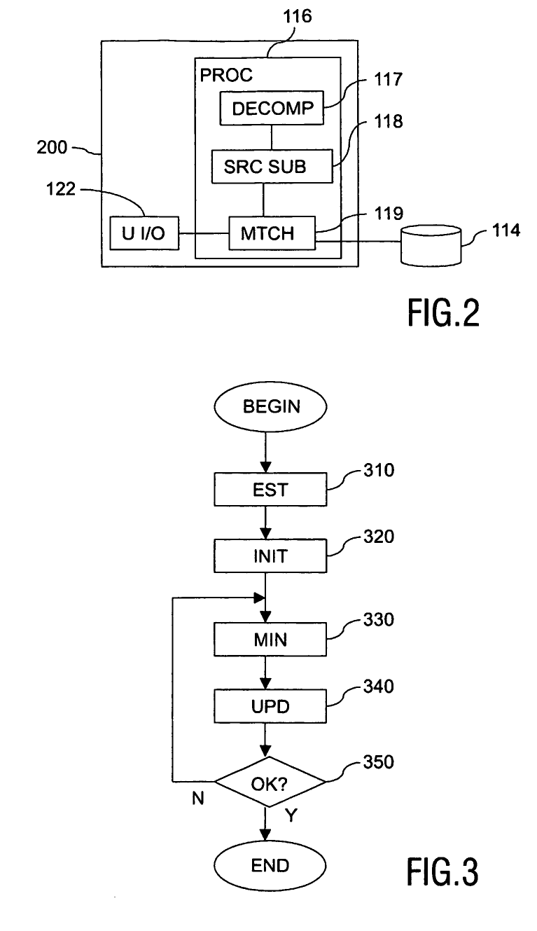

FIG. 2 shows an alternative arrangement wherein the invention is employed in a stand-alone device 200. Such a device could, for example, be a PC or mobile audio player, like the Apple iPod. In FIG. 2, same reference numbers are used for the features that have already been described for FIG. 1. Advantageously, the database also includes for stored audio fragment representations a link to an audio title that incorporates the fragment. The actual audio title may but need not be stored in the database. Preferably, the title is stored in the device itself. Alternatively, it may be accessible through a network. In such a case, the link may be a URL. By linking the match to an actual title, such as an audio track or audio album, a quick selection of the title is possible. It is even possible that by humming a part of an audio track, the track with that part is identified and playback is started fully automatically.

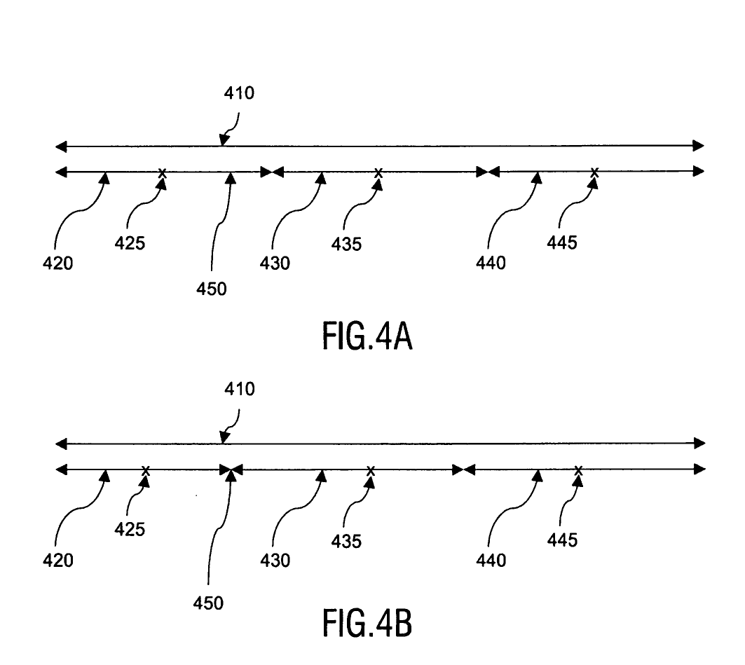

FIG. 3 illustrates a preferred way of decomposing the query string. The decomposition starts in step 310 with estimating how many (Nₛ) sub-strings are present in the query string. In a preferred embodiment this is done by biasing the system to one sub-string per phrase. This can be achieved by calculating the number of notes Nₙₒₜₑₛ represented in the query string. Since a phrase typically consists of 8 to 20 notes, the number of phrases lies between N_{notes/}8 and N_{notes/}20. A first decomposition may be based on using N_{notes/}8 as Nₛ (after suitable rounding). In step 320, the query string is divided into Nₛ sequential sub-strings. A suitable initial division is obtained by using an equidistant distribution. This is illustrated in FIG. 4A. In FIG. 4A, the query string 410 is initially divided into three sub-string, indicated by 420, 430, and 440. Initially those sub-strings are equal-size i.e. represent an equal duration of the audio fragment represented by the query string 410. The sub-strings are sequential and together cover the entire query string 410. Each sub-string 420, 430, 440 is represented by a respective centroid 425, 435 and 445. The centroid, indicated by an X, is visualized in FIGS. 4A and 4B as being located at the centre of its corresponding sub-string. It is well-known how a centroid can be calculated that represents such a sub-string. For example, an audio fragment input by a user is analyzed using equally sized frames of short length (say, 20 ms.). Conventional signal processing is used to extract low-level spectral feature vectors from these frames, in particular those that are suitable to discriminate between different input modalities (i.e. singing styles). Such feature vectors are well-known in the art. Using cepstral coefficients, the centroid is the arithmetic mean of the vectors within the audio sub-string. In this way, an initial value of the centroids is obtained. In reality not all sub-strings will be equal size (phrases and segments input with one modality do in general not have equal duration). This implies that it is now desired to find an optimal location and size of the sub-strings. Preferably, dynamic programming, also known as level-building in the literature, is used to find the optimum. Dynamic programming is well-know in the field of audio processing and, in particular, in the field of speech processing. Given the centroids, the dynamic programming may include, in step 330, varying the length and location of the sub-strings while keeping the centroid values fixed. In this way, a first estimate of the boundaries of the sub-strings is made. This is done by minimizing a total distance measure between each of the centroids and its corresponding sub-string. Persons skilled in the art will be able to choose a suitable distance measure. For example, using cepstral coefficients, a (weighted) Euclidean distance is a proper distance measure. The weighting may be used to emphasize/de-emphasize certain coefficients. In the example of FIG. 4A, a major break between two subsequent parts (e.g. change of input modality) is indicated at location 450. FIG. 4B shows how the boundaries of the sub-strings may be after a first minimization round. In this example, sub-string 420 is shrunk. The left boundary of sub-string 420 is kept fixed at the start of the query string 410. Sub-string 430 has grown a little and the left boundary is shifted left. It will be understood that now the centroid values no longer properly represent the corresponding sub-string. In step 340, new values for the centroids are calculated based on the current sub-string boundaries. The process is repeated iteratively until a predetermined convergence criterion is met. The convergence criterion may be that the sum of the distances between the centroids and its respective sub-string no longer decreases. The criterion is tested in step 350. Optionally, note onsets are detected in the query string (e.g., based on energy level). The note onsets can be used as indicators of phrase boundaries (it is preferred not to cut in the middle of note). Thus, the actual sub-string boundaries may be adjusted to fall in between notes.

In an embodiment, the user may input the query string by mixing a plurality of query input modalities, such as humming, singing, whistling, tapping, clapping, or percussive vocal sounds. The method of FIG. 3 will normally be able to accurately determine the changes between input modality, since such a change will effect the distance measure if suitable centroid parameters are chosen that show the underlying difference in audio for the different input modalities. The audio characteristics of the different input modalities can be summarized as follows:
Singing has a clear pitch, meaning that harmonic components can easily be detected in the spectral representation of the singing waveform. In other words, spectral peaks are multiples of one single spectral peak, that is, the first harmonic or fundamental frequency, which is often referred to as the pitch of the singing. Different voice registers (‘chest’, ‘mid’, ‘head, falsetto’ singing) have distinct frequency ranges.
Percussive sounds (clapping, tapping on a surface) have at best an indefinite pitch, meaning that there are multiple peaks that can be interpreted as the first harmonic. Moreover, percussive sounds are transients or clicks; fast changes in power and amplitude smeared over all frequencies that can be easily identified.
Humming contains a low-frequency band with some midrange frequencies without any prominent spectral peaks.
Whistling has a pitch (first harmonics) range from 700 Hz to 2800 Hz. It is almost a pure tone with some weak harmonics. The lowest whistling tone of a person comes near to the person's highest reachable sung note (so, whistling happens one-and-a-half to two octaves higher than singing).
Noisy sounds are stochastic in nature. This results in a flat spectrum (one energy level) over a band of frequencies (pink nose) or over the complete frequency range (white noise).

Persons skilled in the art will be able to differentiate between more input modalities if so desired.

As an alternative to sub-dividing using the described automatic minimization method, the query string may be subdivided into sub-strings by decomposing the query string into a sequence of sub-strings where each substring of the sequence meets a predetermined classification criterion, and each two sequential substrings meet different predetermined classification criteria. So, if a part of the audio fragment exhibits a defined consistency (e.g. clearly distinguishable notes (pitch) within a defined range that may be used for singing) and a next part shows another consistency (e.g. clearly distinguishable notes but 1.5 octave higher pitch on average, in an range that is typically used for whistling) this result in a different classification of the parts and the change in classification is interpreted as the start of a new sub-string. It will be understood that certain classification criteria may only be fully determined after a pre-analysis of the entire fragment or after a training by the user. Such a pre-analysis may, for example, reveal that the user is male or female and give information on the average pitch used for singing, whistling, etc. Other criteria may be same for each person, e.g. that vocal percussions are mainly toneless (e.g. noisy, with no clearly identifiable pitch). Having established default and/or person-specific criteria the query string (or audio fragment represented by the query string) is analyzed further. Audio features that are used for the classification are determined for parts of the string/fragments and compared against the different classification criteria. Thus, the system preferably includes different sets of classification criteria, each set representing a respective one of the input modalities. The audio features of the fragment being analyzed are compared with each respective criteria set. If the features match (fully or closely) one of the sets, it is established that the audio part is most likely specified via the input modality that corresponds to the set. Classification techniques are well-known. Any suitable technique may be used. An exemplary way of classifying is as follows. Relatively small parts of the fragment are each time analyzed (e.g. ⅓ or ½ of a phrase). During the analysis, an analysis window of such a width may be slided over the total audio fragment. As long as the window fully falls within a consistent part of the entire audio fragment, a relatively close match with the corresponding classification criterion set will be obtained. When the window shifts over a boundary where a change between input modality occurs, the match will be less close and decrease further as the window is shifted further. When the window has been shifted sufficiently far into the next consistent part, a closer match with the classification criterion set for that input modality will be found. The match will improve as the window shifts further into that part. In this way, relatively accurately the boundaries can be detected. The analysis window may be shifted in frame-steps of, for example, 10 to 30 msecs. Once the analysis of the entire audio fragment has been completed and at least one boundary has been detected (in additional to the start and end boundary of the entire audio fragment), sub-strings can be formed within the boundaries.

The classification technique described above can be used for performing the subdivisions into substrings as described above. In a preferred embodiment, the classification is used as a pre-processing for the automatic procedure of FIG. 3 by constraining the position of a substring to fall within two successive boundaries detected using the classification. Constrained dynamic programming techniques are well-known and will not be described here any further.

It will be understood that the classification information described above can not only be used for optimizing finding of the location and size of the sub-strings, but also for improving the search through the database. Having established a best matching consistency criterion for a part of the audio fragment, in most cases also a corresponding input modality is known. This information can be used to improve the search for the sub-string that corresponds to the located part. For example, an optimized database may be used for each input modality. Alternatively, the database may support searching for a same fragment using different input modalities. The input modality is then one additional query item and the database stores for each audio fragment (e.g., phrase) the input modality that was used for specifying the fragment.

In the method illustrated in FIG. 2, the initial estimate of the number of sub-strings is not changed any more. The initial estimate preferably describes the maximum number of sub-strings expected to be present in the entire fragment. Since the fragment may be more consistent than this ‘worst case’ assumption, preferably the same process is also repeated for less sub-strings. In the example of FIG. 2, also a decomposition into two sub-strings may be done and a search performed through the database. The database may also be searched for the entire string. In this way a match of the entire string can be obtained for three sub-strings, two sub-strings and one sub-string (i.e. the entire string). The three outcomes can be compared and a most likely one be presented to the client. Thus, in principle, the query string can be decomposed in many ways, where each decomposition results in a number of sub-strings that can be searched independently in the database. So, the query string as a whole can be searched, independently from the sub-strings that result from the decomposition of the query string in two, independently from the sub-strings that result from the decomposition of the query string in threes, etc. Each search for a sub-string may result in an N-best list of likely candidates. This N-best list may be a list of all melodies in the database ordered on their distance with the sub-string. A total outcome can be created, for example, by combining the lists for all possible decompositions into one list to be presented to the user. The combining can be achieved by merging all lists and sorting on their normalized distances from their sub-string.

As described above, the step of decomposing the query string includes decomposing the query string into sub-strings that each substantially correspond to a phrase. This can be the only decomposition step or it may be used in combination with other decomposition steps/criteria such as a further decomposition after having performed a decomposition aimed at sub-division for changes in input modality. Phrases may be detected using in any suitable way. Phrases are often ended by a slowing down of the humming. Or, phrases are discriminative by large tone differences (i.e. intervals) and large tone durations. Phrase detection algorithms are known, for example from “Cambouropoulos, E. (2001). The local boundary detection model (lbdm) and its application in the study of expressive timing. In Proc. ICMC 2001” and “Ferrand, M., Nelson, P, and Wiggins, G. (2003). Memory and melodic density: A model for melody segmentation. In: Proc. of the XIV Colloguiu on Musical Informatics (XIV CIM 2003), Firenze, Italy, May 8-9-10, 2003.”

It will be appreciated that the invention also extends to computer programs, particularly computer programs on or in a carrier, adapted for putting the invention into practice. The program may be in the form of source code, object code, a code intermediate source and object code such as partially compiled form, or in any other form suitable for use in the implementation of the method according to the invention. The carrier be any entity or device capable of carrying the program. For example, the carrier may include a storage medium, such as a ROM, for example a CD ROM or a semiconductor ROM, or a magnetic recording medium, for example a floppy disc or hard disk. Further the carrier may be a transmissible carrier such as an electrical or optical signal which may be conveyed via electrical or optical cable or by radio or other means. When the program is embodied in such a signal, the carrier may be constituted by such cable or other device or means. Alternatively, the carrier may be an integrated circuit in which the program is embedded, the integrated circuit being adapted for performing, or for use in the performance of, the relevant method.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. A method of searching for a match for a query string, that represents an audio fragment, in a melody database; the method including:
decomposing the query string into a sequence of a plurality of query sub-strings;
for each sub-string, independently searching the database for at least a respective closest match for the sub-string; and
in dependence on the search results for the respective sub-strings, determining at least a closest match for the query string.

2. A method of searching for a query string as claimed in claim 1, wherein the step of decomposing the query string includes decomposing the query string into sub-strings that each substantially correspond to a phrase.

3. A method of searching for a query string as claimed in claim 1, including enabling a user to input the query string mixing a plurality of query input modalities.

4. A method of searching for a query string as claimed in claim 3, wherein at least one of the query input modalities is one of: humming, singing, whistling, tapping, clapping, percussive vocal sounds.

5. A method of searching for a query string as claimed in claim 3, wherein a change in query input modality substantially coincides with a sub-string boundary.

6. A method of searching for a query string as claimed in claim 1, wherein the step of decomposing the query string includes:
estimating how many (Nₛ) sub-strings are present in the query string;
dividing the query string in Nₛ sequential sub-strings; each sub-string being associated with a respective centroid that represents the sub-string;
iteratively:
for each centroid determining a respective centroid value in dependence on the corresponding sub-string; and
determining for each of the sub-string corresponding sub-string boundaries by minimizing a total distance measure between each of the centroids and its corresponding sub-string;
until a predetermined convergence criterion is met.

7. A method of searching for a query string as claimed in claim 2, wherein the step of estimating how many (Nₛ) sub-strings are present in the query string includes dividing a duration of the audio fragment by an average duration of a phrase.

8. A method of searching for a query string as claimed in claim 5, wherein the step of decomposing the query string includes retrieving for each of the input modalities a respective classification criterion and using a classification algorithm for based on the classification criteria detecting a change in query input modality.

9. A method of searching for a query string as claimed in claim 3, including constraining a substring to fall within two successive changes in query input modality.

10. A method of searching for a query string as claimed in claim 1, wherein the step of searching for each sub-string in the database includes generating for the sub-string an N-best list (N>=2) of the N most closest corresponding parts in the database with a corresponding measure of resemblance; and performing the determining of the at least closest match for the query string based on the measures of resemblance of the N-best lists of the sub-strings.

11. A computer program product operative to cause a processor to execute the steps of the method as claimed in claim 1.

12. A system for searching for a query string, that represents an audio fragment, in a melody database; the system including:
an input (122, 132) for receiving the query string from a user;
a melody database (114) for storing respective representations of plurality of audio fragments;
at least one processor (116) for, under control of a program,
decomposing (117) the query string into a sequence of a plurality of query sub-strings;
for each sub-string, independently searching (118) the database for at least a respective closest match for the sub-string; and
in dependence on the search results for the respective sub-strings, determining (119) at least a closest match for the query string.
